(19) United States
(12) Patent Application Publication
(10) Pub. No.: US 2016/0004562 A1
(43) Pub. Date: Jan. 7, 2016

(54) Method of Centralized Planning of Tasks to be Executed by Computers Satisfying Certain Qualitative Criteria Within a Distributed Set of Computers

(71) Applicant: JADE-I, Paris (FR)

(72) Inventors: Laurent Vieille, Noisy Le Roi (FR); David Levy, Paris (FR)

(73) Assignee: JADE-I, Paris (FR)

(21) Appl. No.: 14/770,462

(22) PCT Filed: Feb. 25, 2014
(86) PCT No.: PCT/FR2014/050404

§ 371 Date: Aug. 25, 2015

(30) Foreign Application Priority Data
Feb. 27, 2013 (FR) 1351744

(51) Int. Cl. G06F 9/48; G06F 3/0484; H04L 29/08; G06F 3/0486

(52) U.S. Cl. CPC G06F 9/4806; G06F 3/0486; G06F 3/04842; H04L 67/10

(57) ABSTRACT

A method of disseminating a planning of tasks in a network of distributed computers. The network includes a planning server, the programming on the planning server, of a planning of tasks for at least one class of distributed computers; and, independently the defining of ranges of transfer to the distributed computers of information allocated to each distributed computer, the transfer range being defined as a function of the constraints of the network; the splitting of the planned tasks into scheduling information, for each distributed computer and for a period of time dependent on the transfer ranges defined, the scheduling information being generated as a function of the class or classes to which the computer belongs; the transfer to the distributed computers of the scheduling information while complying with the transfer ranges defined.

The present invention relates to a method of disseminating a planning of tasks in a network of distributed computers, the distributed computers being qualified by at least one predetermined criteria allowing to define classes of distributed computers, the network further comprising a planning server. It also relates to a computer program product for implementing the method as well as a human-machine interface system comprising a screen and a device for typing information for managing task planning in a network of distributed computers, the distributed computers being qualified by at least one predetermined criteria allowing to define classes of distributed computers.

More particularly, it relates to a method of centralized planning of tasks to be executed based on the date and time by each of the computers verifying certain Qualitative Criteria within a distributed set of computers, for the transfer to each of these computers of scheduling information concerning it.

There are known different methods allowing a program product the representation and manipulation of calendar and task scheduling.

A first example of such a method is used in particular within program products serving to manage calendars. In this method, a calendar event is represented by a datum and the various characteristics thereof, such as its date and time, place, periodicity and participants. The duration of an event is generally short (less than a day). Such a method allows in particular the definition of alerts, the detection of conflicts and the manipulation of the events by means of interfaces in particular graphic ones.

A second example of such a method is in particular used within program products serving to schedule the execution of tasks: a task is represented by a datum and its diverse characteristics, such as its duration, the affected resources (people, equipment), previous tasks, a start or end date. The duration of such a task varies from a few hours to a few days, weeks or months. Such a method allows in particular the computation of the total execution duration of a set of tasks, scheduling propositions, detecting conflicts in the making of the resources available.

Likewise, there are known various methods for indicating to a computer the tasks which should be executed according to the date and time. These methods generally use the clock of the computer, Scheduling information and a “daemon” process, executed in a quasi-permanent manner by the computer. The state of the art consists in representing the Scheduling Information in the form of a table specifying the tasks to be executed according to the date and time. (This table is sometimes called “crontable”). Usage examples of such methods are present in most computer operating systems.

These various methods are not appropriate in situations where an Expert wishes to plan the execution of tasks at defined dates and times, on a distributed set of Computers characterized only by Qualitative criteria. Such an environment may be specified as follows:
a set of distributed Computers, all capable of executing the same tasks, their variable and important number rendering the non-automated management of lists of these Computers impractical,
a variety of Qualitative criteria characterizing the Computers
a Planning server within which IT data represent each Computer, with the Criteria characterizing them,
a communication network between the Planning server and each of the Computers, allowing them to exchange data, particularly to transfer the Scheduling Information to the Computers.

The Expert may specify a task Planning characterized by the following parameters, hence without any explicit mention of each Computer:
the start and end dates,
the task or tasks which must be executed,
the days and timetables according to which these tasks must be carried out,
the Qualitative Criteria such that any Computer verifying these Criteria executes the task or tasks specified on the due days and timetables.

A particular case of this situation occurs when a marketing expert plans questions to be asked to Clients of a store on the terminal used for validating the payment, after the transaction. In this situation, the question to be asked to the Client acts as task to be executed, the Payment Terminal acts as Computer, and may be qualified, in particular, by the following criteria:
the store where it is located,
the groupings of stores, in particular geographical (regions, countries . . . ), by type (showroom, small or large store, etc.), by environment (rural urban, peri-urban),
the signs or franchises to which the store belongs,
the class of products or services of which the payment is ensured by the Terminal (food, fuel, jewelry),
type of checkout (priority to certain people, priority for small purchases, “self checkout” where the client himself/herself registers his/her own purchases).

The Scheduling Information indicate the questions to be asked by the Terminal, at a given date and time. According to the capacities of the communication network, this information must be saved on the Terminal for one or several days, or even longer.

Another particular case of this situation is during the planning of supervising, measuring, regulating operations of a distributed set of Smart Meters. This planning is carried out by an electrical networks Expert. A task to be executed may be the application of a regulating mode (starting the high consumption apparatuses), of a utilization pattern of electricity sources (solar panels, network), etc. A smart meter may thus be qualified in particular, by the following Criteria:
type of client (main or secondary residence, office, workshop),
his/her location, in particular geographical (town, countryside, coastline),
type of equipment (solar panels, electric water heater, . . . ).

Scheduling information indicate the regulating or utilization modes of sources of electricity according to the Criteria applicable to the Meter according to the date and time.

None of the above-mentioned methods correctly processes the Centralized Planning of tasks to be executed, on the basis of Qualitative Criteria, to Distributed Computers. A naïve approach may include the following aspects and drawbacks:
Treating the Computers as essential resources for the execution of a task. Verifying the prerequisites to the execution of a task, is one of the purposes of task scheduling methods. Here, the purpose differs: it consists in planning the execution of tasks on all the Computers verifying the Qualitative Criteria.
Asking the expert to plan the tasks for each of the Computers. The number of Computers (in France: more than a million Payment Terminals, tens of millions of electric meters) and the variation frequency of the lists, make this approach impossible.
Immediately translating a Centralized planning of tasks based on Criteria of Scheduling Information for each Computer. This approach is particularly inefficient:
   necessity of re-computing Scheduling information:
   During the modification of the Centralized planning,
   During the modification of the Criteria of a Computer,
   During the modification of the list of the Computers.
   storage of redundant data by duplicating information:
   For each Computer sharing the same Criteria,
   For each day and time slot of a planning period, even though this period is long.
Transmitting the Scheduling information without optimization.

Often the tasks are planned for a much longer period than the time units used during the planning (example: hours or minutes) and by the Computers. Transmitting the Scheduling information without optimization over several days or weeks would be an unreasonable use of the resources (pass-band . . . )

In order to resolve several of the aforementioned drawbacks, a method of disseminating task planning within a network of distributed computers, the distributed computers being qualified by at least one predetermined criterion allowing to define classes of distributed computers, the network further comprising a planning server, comprises:
the programming, on the planning server, of a task planning for at least one class of distributed computers; and, independently,
the definition of ranges of transfer towards the distributed computers of information attributed to each distributed computer, the transfer ranges being defined according to the network constraints;
the distribution of the planned tasks into scheduling information, for each distributed computer and for a period of time dependant on the defined transfer ranges, the scheduling information being generated according to the class or classes to which the computer belongs;
the transfer towards the distributed computers of the scheduling information by respecting the defined transfer ranges.

In particular embodiments, usable alone or in combination:
a default class is further defined on the planning server and the scheduling information for this default class are transferred to any computer added to the set of distributed computers outside the transfer ranges;
at least one intermediate computer controls a cluster of distributed computers and is the recipient of the scheduling information for the computers of the cluster which it controls;
the size of the scheduling information is optimized by using a semantic representation of the latter;
at least one network constraint comprises a discontinuous availability towards at least part of the distributed computers; and/or
the transfer ranges are of available type or which can be activated, and in that a modification of the planning is, further authorized if a transfer range which can be activated allows transferring the scheduling information resulting from the modification.

According to a second aspect of the invention, a computer program product includes program code instructions saved on a support readable by a computer, for implementing the steps of the above method.

According to a third aspect of the invention, a human-machine interface system comprising a screen and a device for typing information for managing a planning of tasks within a network of distributed computers, the distributed computers being qualified by at least one predetermined criterion allowing to define classes of distributed computers, further comprises:
means for displaying on the screen of a typical planning period; and
means for displaying on the screen a calendar period to be planned;
the typing device being suitable for programming, deleting or replacing a task by dragging and dropping a representation of the task towards the typical period; then for generating a validation allowing to transfer the planning thus defined over a typical period towards a calendar period.

According to particular embodiments which can be used alone or in combination:
the typing device is further suitable for adding, deleting or replacing a task by the day or according to a time slot;
the typing device is suitable for allowing a modification over a calendar period; and/or
it further comprises means for displaying at least one class of distributed computers and that the typing means are suitable for associating a planning to said class.

Thus, the method has the following advantages:
Having the capacity of representing the Centralized planning in the form of IT data, with the parameters characterizing them;
Allowing an Expert to create, modify, delete the Centralized planning by means of a particular graphic, interface;
Representing, storing and allowing the modification of the data representing each Computer and the Criteria qualifying it, by methods in the state of the art;
Having the capacity of representing and storing in the form of IT data, the Scheduling Information of the tasks to be executed by a Computer according to the date and time;
Defining the Transfer Ranges for the communication of the Scheduling Information to the Distributed Computers, ranges compatible with the operating mode of the Computers and the communication network;
At the moment preceding the transfer of the Scheduling Information to the Computers:
   Classifying the Computers on the basis of the Qualitative Criteria: two Computers belong to the same Class if and only if their Criteria are identical;
   Generating the Scheduling Information for each of these classes based on Centralized Planning and Criteria defining each Class;
   Optimizing the Scheduling Information in order to minimize the use of resources of the Computer and the communication network; this optimization uses a semantic representation of the Scheduling Information.
Transmitting the Scheduling Information to the Computers;
Archiving the Scheduling Information for maintenance needs (resumption in the event of failure, supervision, statistics).

This method is extended in order to allow the dynamic adding and removal of Computers, without prior declaration to the Planning Server. In the case of dynamic adding, the Criteria characterizing a Computer may be unknown during transfers of Scheduling Information to this Computer.
The point (b) is completed by “Allowing an Expert to define the default Qualitative Criteria used for a Computer of which the Criteria have not been defined;”
The point (g) is completed by “Making available to the Computers added dynamically the Scheduling Information corresponding to the default Criteria;”

This method is extended in order to take into account the Distributed Organizations, in which Intermediate Servers each control a cluster of Computers. A particular situation of Distributed Organization is that of the Payment terminals of a store of a chain of distribution. It frequently occurs that these Terminals be controlled by a local or remote server.
The point (g) is completed by “Gathering the Scheduling Information necessary for all the Computers served by an Intermediate Server, as well as those corresponding to the default Criteria, and transmitting them to the Intermediate Server.”

This method is extended in order to allow the good operating even if the network has a discontinuous availability towards at least part of the computers. In this case, transfer ranges compatible with the availability of the network are defined, some as “available”, that is to say, that Scheduling Information will be transferred to each occurrence of an available range, and others “which can be activated”, that is to say which can be used upon request.

By way of example, it is commonplace that the payment terminals connect once a day, at night, to a master server, in such a manner as to transfer information. In this situation, the “available” transfer ranges may be defined as those occurring in the night of Sunday to Monday, and those “which can be activated, those occurring every night.

This method is extended, in the case where the network has a discontinuous availability, in order to allow only the modifications of the Centralized Planning which can be transmitted on time to the concerned computers. In reference to the example of the payment terminals connecting once a day at night (above):

a) a modification of the Planning for a week to come does not lead to the use of a transfer range “which can be activated”, the “available “ranges being enough for transmitting the Scheduling Information;

b) The planning modifications for the following day or for the days to come of the current week are authorized: a transfer range “which can be activated” may be used for transferring the new Scheduling Information;

c) The planning modifications for the current day are not authorized, as no transfer range “which can be activated” allows the transfer of the Scheduling Information resulting from such a change.

This method is completed by a human-machine interface system comprising a screen and a typing device for providing a graphic interface (b) allowing to plan, delete or replace one or several tasks simultaneously, define the Criteria of the Computers to which the Planning applies, and rapidly define weeks or periods to which the planning applies. This system allows limiting to one single dragging and dropping operation of a representation of the task and to one single validation operation, a planning modification concerning an entire calendar period,

The method may advantageously be implemented in the form of a computer program product, for example a script, formed of instructions. This computer program product is accordingly installed on the planning server for executing the different steps of the method.

The invention will be better understood upon reading the following description, made by way of example only, and with reference to the accompanying figures in which:

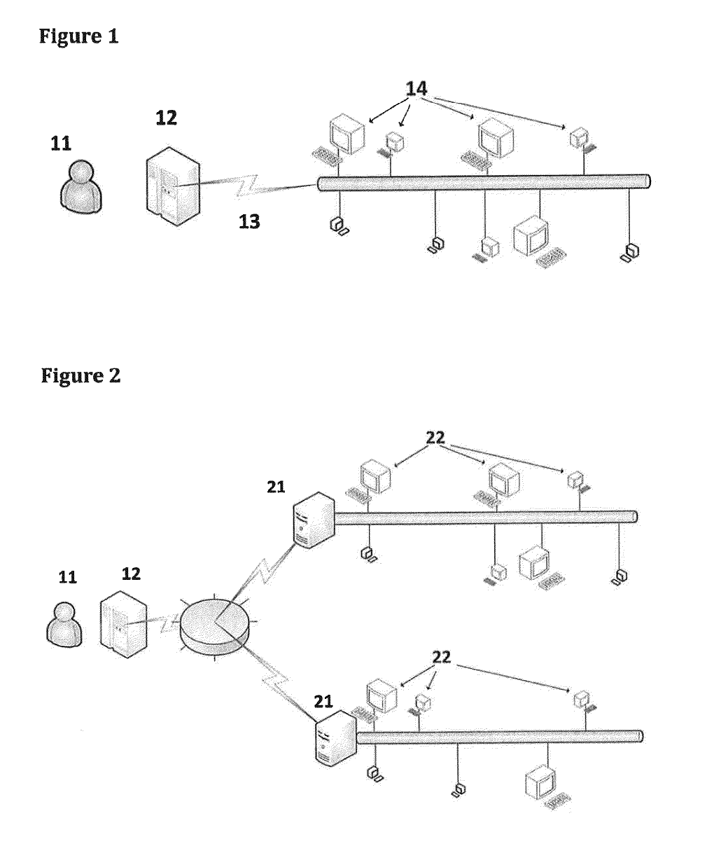

FIG. 1 is a schematic view of the environment;

FIG. 2 is a schematic view of Distributed Organization;

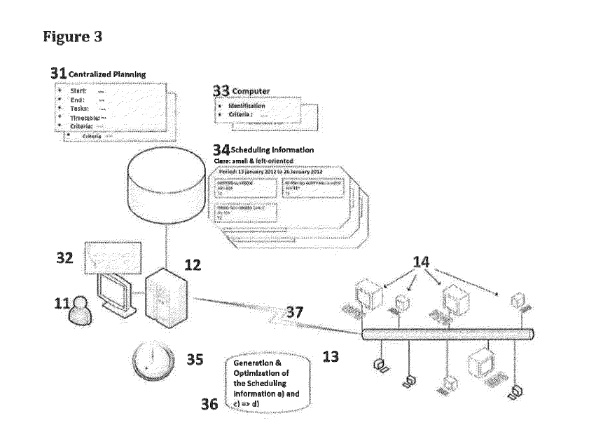

FIG. 3 provides a general representation of the method;

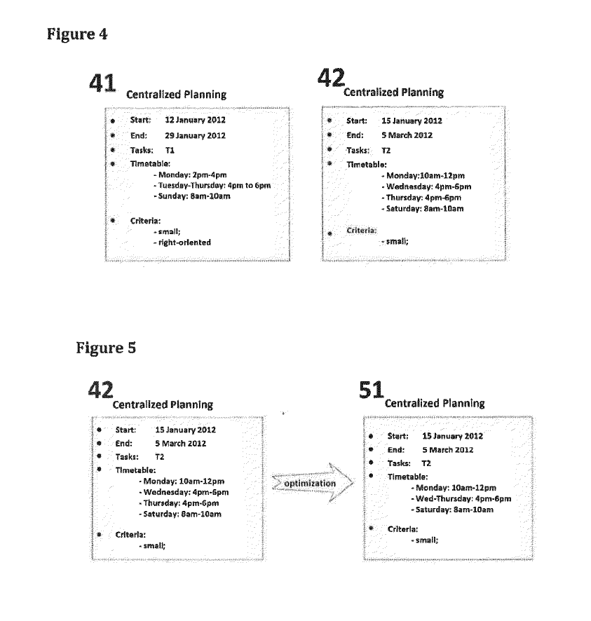

FIGS. 4 and 5 illustrate a representation of Centralized planning, according to an embodiment of the invention;

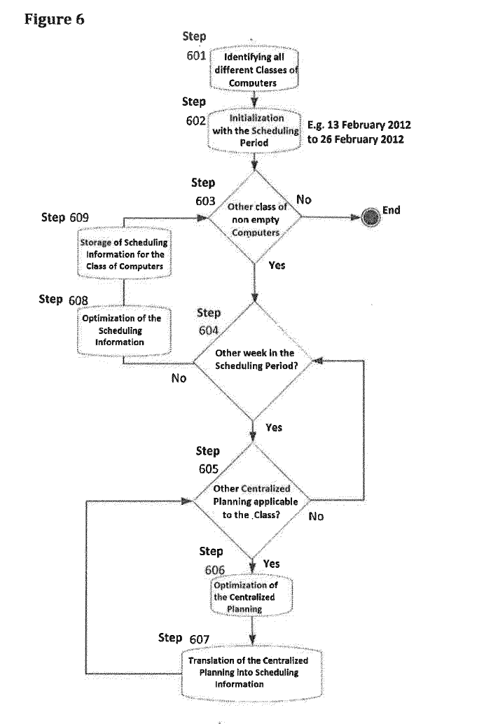

FIG. 6 is a flow chart of a sub-method for the step □ of the method, aiming to generate and optimize the Scheduling Information for the classes of Computers, according to an embodiment of the invention;

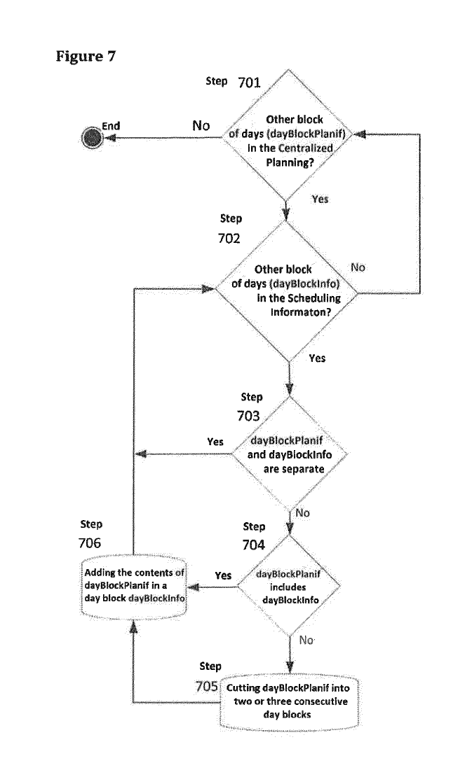

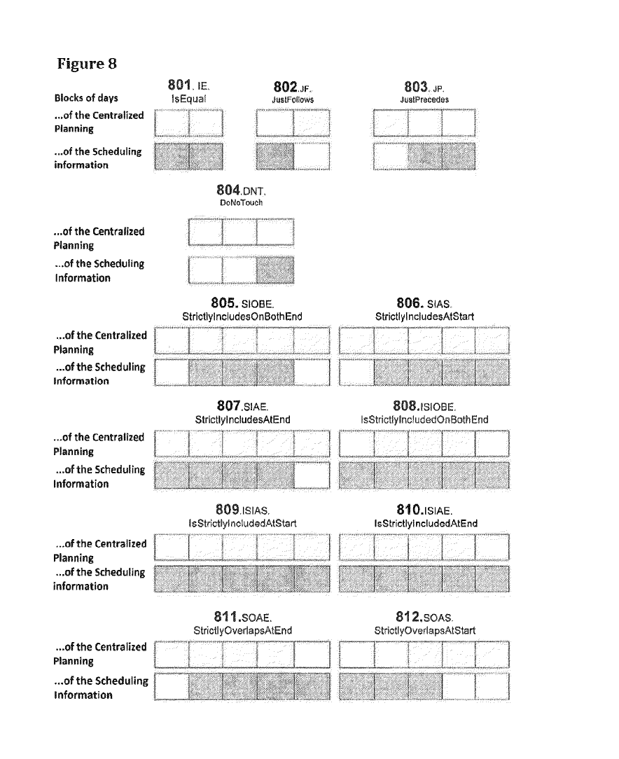

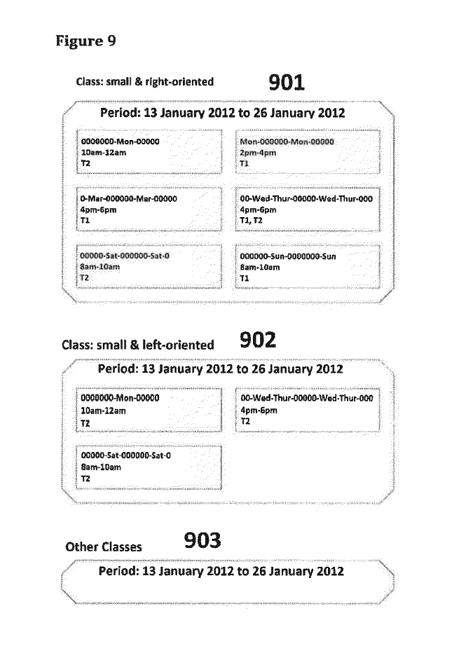

FIG. 7 is a is a sub-flow chart of the method of FIG. 6; this sub-flow chart uses the specific information on the cases of period intersection presented on FIG. 8, in order to obtain a compact information, according to a semantic representation, such as represented on FIG. 9;

FIG. 8 presents cases of period intersection, used in the flow chart of FIG. 7;

FIG. 9 illustrates an optimized representation of the Scheduling Information for Classes of Computers, according to an embodiment of the invention;

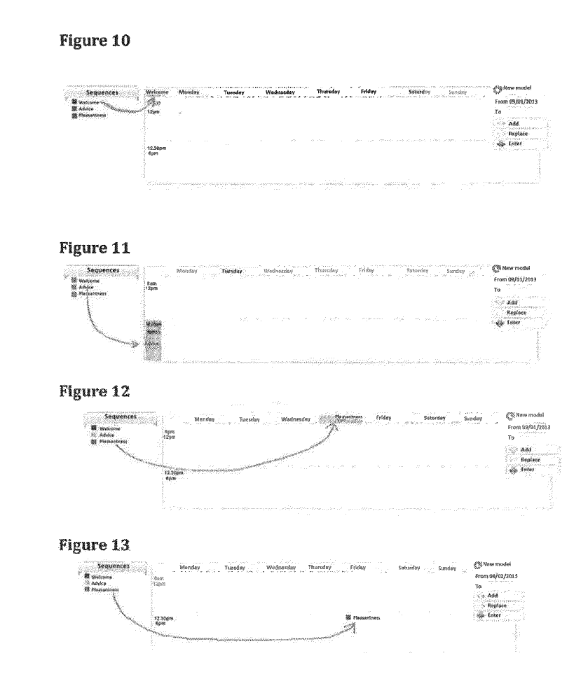

FIGS. 10 to 15 represent different use cases of a graphic interface for defining and updating Centralized Planning, according to an embodiment of the invention.

In reference to FIG. 1, the Expert (11) uses a Planning Server (12) connected to the computers (14), by means of a communication network (13). The Qualitative Criteria introduced as an example are the orientation (right/left), the size (small/medium/large): The Expert may plan some tasks on the “right-oriented” and “small” size Computers and other tasks on the “left-oriented” and “large” size Computers.

In reference to FIG. 2, the Intermediate Servers (21) each control a cluster of Computers (22); the Criteria verified by each Computer are independent from the Intermediate Server which controls it.

In reference to FIG. 3 the elements indicated by letters from (31) to (37) represent the steps (a) to (g) of the method, and those from (11) to (14) are the elements of the environment introduced by FIG. 1.

In reference to FIG. 4, the elements illustrate a possible representation of Centralized Planning, where the Criteria refer to FIG. 1.

A Centralized planning is characterized by
its start and end dates,
the Qualitative Criteria,
the Tasks, and
a Typical Week in which periods from one or several consecutive days are divided into homogenous time slots.

By way of example, on this FIG. 4, the Centralized Planning (41) indicates that the task T1 is to be executed on Mondays from 2 pm to 4 pm, from Tuesdays to Thursdays between 4 pm and 6 pm and Sundays from 8 am to 10 am, by the Computers which are “small” and “right-oriented”, from 12 to 29 Jan. 2012. The Centralized Planning (42) indicates that the task T2 is to be executed by the “small” Computers on Mondays between 10 am and 12 pm, Wednesdays from 4 pm to 6 pm and Saturdays from 8 am to 10 am, from 15 Jan. to 5 Mar., 2012.

Consequently, for example:
The “small” “right-oriented” Computers verify the Planning Criteria (41) and (42). Thus Wednesdays between 4 pm and 6 pm, they must execute:
   From 12 January to 14 January, task T1;
   From 15 January to 29 January, tasks T1, T2;
   From 30 January to 5 March, task T2;
The “small” “left-oriented” Computers only verify the Planning Criteria (42). Thus, Wednesdays between 4 pm and 6 pm they must only execute:
   From 15 January to 5 March, task T2;
The Computers other than small, do not verify the Criteria of any Planning: they have no task to execute on Wednesdays between 4 pm and 6 pm in this respect.

In reference to FIG. 5, the Centralized Planning (51) results from an optimization of the Centralized Planning (42), where the two periods “Wednesday from 4 pm to 6 pm” and “Thursday from 4 pm to 6 pm” have been combined into one single period “Wed-Thursday from 4 pm to 6 pm”.

In reference to FIG. 6, the flow chart includes the following steps:
The step 601 consists in identifying the Classes of Computers on the basis of the Qualitative Criteria according to the definition on page 7;
The step 602 consists in initializing the Scheduling Information with the considered Scheduling Period.
   The example given on FIG. 6 goes from 13 Feb. to 26 Feb. 2012.
The step 603 consists in enumerating the Classes of non-empty Computers (including that corresponding to the default Criteria):
   for each of the Classes, the sub-method passes to Step 604;
   at the end of the enumeration, the sub-method ends;
The step 604 consists in enumerating the weeks of the Scheduling Period;
   for each of the weeks, the sub-method passes to the step 605;
   at the end of this enumeration, the sub-method finalizes the Scheduling Information for the Class throughout steps 608 and 609 before returning to the step 603;
The step 605 consists in enumerating the Centralized Planning applicable for the considered Class and for the considered week:
   A centralized Planning is applicable for the considered Class if and only if each specified criteria for the Centralized Planning is verified by the Class; if one criterion is not specified for the Centralized Planning, it is ignored;
   for each Planning, the sub-method passes to the step 606;
   at the end of this enumeration, the sub-method continues the enumeration of the step 604;
The step 606 consists in optimizing the centralized Planning by regrouping the periods of one or several contiguous days when their content is identical (see method illustrated by FIG. 5);
The step 607 consists in inserting the information of the Centralized Planning in the Scheduling Information for this Class of Computer and this Period. This step is executed, according to an implementation of the method, according to the sub-flow chart illustrated on FIG. 7 and commented below.
The step 608 consists in optimizing the Scheduling Information; the periods obtained by gathering the Scheduling Information with identical content (same time slot and same list of tasks) but at different periods (for example from different weeks) in order to obtain a compact Scheduling Information such as represented on FIG. 9;
The step 609 consists in storing the Scheduling Information for transfer to all concerned Computers or Intermediate Servers.

The sub-method illustrated on FIG. 6 is presented for a Scheduling period composed of entire and adjoining weeks, for the sake of simplicity.

It is easily extensible for non-entire and not necessarily adjoining weeks.

In reference to FIG. 7, the sub-flow chart included in the sub-method illustrated on FIG. 6 includes the following steps:
The step 701 consists in enumerating the consecutive blocks of days “DayBlockPlanif” present in the Centralized Planning:
   For each block, the sub-method continues to step 702;
   at the end of this enumeration, the sub-method ends;

For example, in reference to the Centralized planning (51) of the FIG. 5, the blocks of enumerated days are: Monday, Wed-Thursday, Saturday;
The step 702 consists in enumerating the consecutive blocks of days “DayBlocklnfo” already present in the Scheduling Information;
For each block, the sub-method continues to step 703.
at the end of this enumeration, the sub-method continues the enumeration of step 701;

For example, during the first iteration over the first week of the period from 13 to 26 Feb. 2012 indicated on FIG. 6, the only block DayBlocklnfo is Mon-Sun, with empty contents;
The step 703 determines if DayBlockPlanif and DayBlocklnfo are separate. These cases correspond to the cases signaled by 802 (JustFollows), 803 (JustPrecedes), 804 (DoNotTouch) on FIG. 8;
   If it is the case, the sub-method continues the enumeration of step 702;
   otherwise, it passes to step 704;
The step 704 determines if DayBlockPlanif includes DayBlocklnfo. These cases are signaled by 801 (IsEqual), 805 (StrictlylncludesOnBothEnd), 806 (StrictlylncludesAtStart), 807 (StrictlylncludesAtEnd) on FIG. 8;
   If it is the case, the sub-method passes to step 706;
   otherwise it passes to step 705;
The step 705 consists:
   In dividing DayBlocklnfo into two new day blocks, in the cases signaled by 809 (IsStrictlylncludedAtStart), 810 (IsStrictlylncludedAtEnd), 811 (StrictlyOverlapsAtEnd), 812 (StrictlyOverlapsAtStart) on FIG. 8, or three new blocks of days, in the signaled case 808 (IsStrictlylncludedOnBothEnd) on FIG. 8, and of content identical to DayBlocklnfo;
   In deleting DayBlocklnfo from the Scheduling Information and replacing it with the two or three day blocks;
The step 706 consists in adding the tasks by time slot present in DayBlockPlanif to DayBlocklnfo (in the case of success of Step 704) or in the period resulting from the step 705 and intersecting with DayBlockPlanif.

In reference to FIG. 9, the blocks 901, 902, 903 schematically represent the format which the Scheduling Information may take according to an implementation of the method. (The data correspond to the Classes of Computers of FIGS. 1 and 2 and to the Planning of FIG. 4, optimized according to the method illustrated by FIG. 5. For example, the block 901 represents the scheduling Information for the “small” and “right-oriented” Class of Computers; the block 902 the scheduling Information for the “small” and “left-oriented” Computers; the block 903 for the other computers. Each of the sub-blocks in one of these blocks corresponds to separate periods, and contains the following information:
the list of days to which the Scheduling Information applies (“0” if the information does not apply to the corresponding day, “1”, replaced here by an abbreviation of the day, if the Information applies),
the time slot, and
the list of tasks to be executed.

In reference to FIGS. 10, 11, 12, 13 and 14, the diagrams illustrate the operating of a graphic interface for proceeding with the centralized planning of the questions. This interface allows in one single (or several) operation(s) to drag-drop followed by a validation click, to plan, one (or several question(s) for a particular week or several consecutive weeks (with or without end), that each question is to be asked during the entire week, during a particular day of the week or a particular day of the calendar or every day during a particular time slot. The interface is such that one single dragging and dropping operation is needed to define the planning of a question, the validation click allowing to validate a set of planned questions.

The graphic interface uses any typing device in the state of the art in order to carry out the dragging and dropping operation then enter the validation click: this may be a pointing device independent from the screen, such as a mouse or a track-ball, just as it could be a device allowing to point directly on the screen, like a capacitive or resistive, touch screen,

The diagrams show the dragging and dropping action to be carried out; once the considered question deposited, it appears in the typical week or considered particular week on the days selected by the dragging and dropping action:
on FIG. 10, dragging and dropping the question “Welcome” towards the top left corner of the typical week, followed by the choice of the period in the windows above the “add” button, then validating this “add” button on the right side of the typical week allows planning the “Welcome” question for the entire indicated period, and for all the days of the week;

See on FIG. 13 below the result of this planning over the calendar period.
on FIG. 11, dragging and dropping the “Advice” question to the left side, in the time slot 12.30 pm-6 pm, followed by the choice of the period in the windows above the “add” button, then validating this “add” button on the right side of the typical week allows planning the “Advice” question for the entire indicated period, only during the specified time slot;

See on FIG. 13 below the result of this planning over the calendar period.
on FIG. 12, dragging and dropping the “Pleasantness” question towards the header of a particular day of the typical week, followed by the choice of the period in the windows above the “add” button, then validating this “add” button on the right side of the typical week allows planning the “Pleasantness” question during the entire indicated period, only for the day of the specified week.

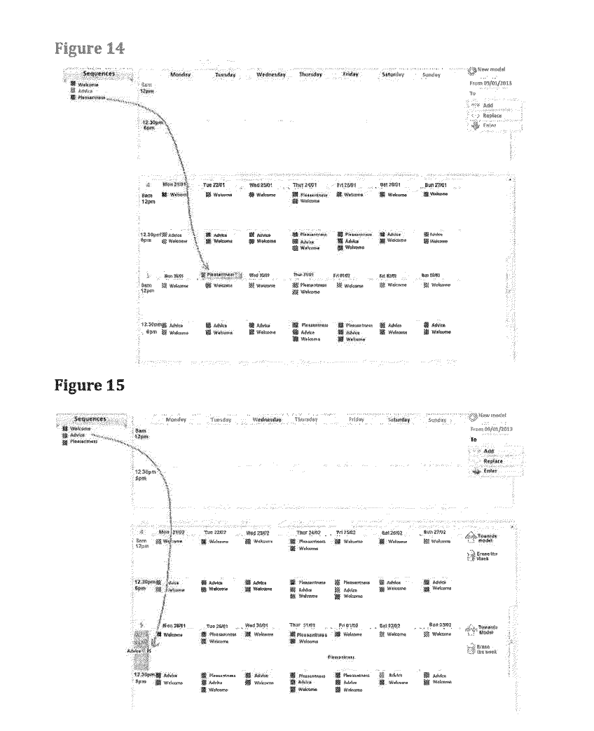

See on FIG. 14 below the result of this planning over the calendar period.
On FIG. 13, dragging and dropping the “Pleasantness” question towards a time slot of a particular day of the typical week, then the question will be planned during the specified period, the specified day and for the specified time slot.

See on FIG. 14 below the result of this planning over the calendar period.
On the same FIGS. 10, 11, 12 and 13, the typical week may be composed of several questions dragged and dropped successively on identical or different days, and for identical or different gaps, then validated on the defined period.
On the same FIGS. 10, 11, 12 and 13, the validation of the “Replace” button instead of the “Add” button will replace the programming over the considered period, and the validation of the “Remove” button will remove the programmed questions in the typical week over the considered period.
On FIG. 14, dragging and dropping the “Pleasantness” question on a particular day (29/01), followed by a validation, allows planning this question only for that particular day.

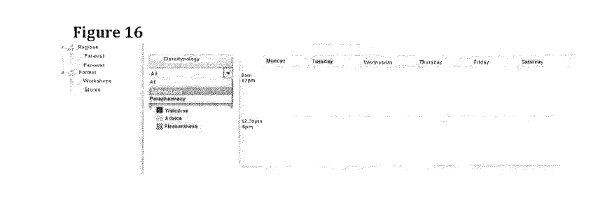

FIG. 14 also illustrates the result of the operations presented on FIGS. 10, 11, 12 and 13: the “Welcome” question is planned every day of the calendar period; the “Advice” question is planned every afternoon of the calendar period; the “Pleasantness” question is planned every Thursday of the calendar period;
On FIG. 15, dragging and dropping the “Advice” question on the left side of a particular week (week of 28/01 to 03/20 in the example), in a specific time slot, followed by a validation, allows planning this question for that particular week and that time slot.
On FIG. 16, a representation of the Qualitative Criteria applying to the Computers allows specifying, by means of the typing tool, to indicate the Class of Computers for which the planning is carried out.

According to this method, it is possible to plan a question for a particular week (every day/all time slots of that particular week), for a time slot of a particular day.

According to a derivative method, it is possible to unplan a question in all the same cases as those mentioned below.

According to a derivative method, it is possible to drag and drop several questions in one single operation, thanks to a multi-selection operation prior to dragging and dropping. According to a particular implementation, this multi-selection operation is carried out by selecting these questions after each other with the mouse while maintaining a particular key pressed down.

According to a derivative method, it is possible to characterize the Criteria of the Computers to which the Planning must apply be selecting these criteria according to standard selection means, by browsing in trees, by multi-criteria selection, by selecting from a list. In reference to FIG. 15, it is possible to select one or several groups of stores in the left tree and one or several classes of checkpoints in the selection list.

1.-11. (canceled)

12. A method of disseminating task planning within a network of distributed computers, the distributed computers being qualified by at least one predetermined criterion allowing to define classes of distributed computers, the network further including a planning server, comprising:
the programming, on the planning server, of a task planning for at least one class of distributed computers; and, independently,
the definition of ranges of transfer towards the distributed computers of information attributed to each distributed computer, the transfer ranges being defined according to the network constraints;
the distribution of the planned tasks into scheduling information, for each distributed computer and for a period of time dependent on the defined transfer ranges, the scheduling information being generated according to the class or classes to which the computer belongs;
the transfer towards the distributed computers of the scheduling information by respecting the defined transfer ranges.

13. The method according to claim 12, wherein a default class is further defined on the planning server and the scheduling information for this default class is transferred to any computer added to the set of distributed computers outside the transfer ranges.

14. The method according to claim 12, wherein at least one intermediate computer controls a cluster of distributed computers and is the recipient of the scheduling information for the computers of the cluster which it controls.

15. The method according to claim 12, wherein the size of the scheduling information is optimized by using a semantic representation of the latter.

16. The method according to claim 12, wherein at least one network constraint comprises a discontinuous availability towards at least part of the distributed computers.

17. The method according to claim 16, wherein the transfer ranges are of type available or of the type which can be activated, and a modification of the planning is further authorized if a transfer range which can be activated allows transferring the scheduling information resulting from the modification.

18. A computer program product including program code instructions saved on a support readable by a computer, for implementing the steps of a method according to claim 12.

19. A method according to claim 12, wherein the programming step is carried out by means of a human-machine interface system comprising a screen and an information typing device for managing task planning in a network of distributed computers, the distributed computers being qualified by at least one predetermined criteria allowing to define classes of distributed computers, the system further comprising:
means for displaying on the screen of a typical planning period; and
means for displaying on the screen a calendar period to be panned;
the typing device being suitable for programming, deleting or replacing a task by dragging and dropping a representation of the task towards the typical period; then for generating a validation allowing to transfer the planning thus defined over a typical period towards a calendar period.

20. A method according to claim 19, wherein the typing device is further suitable for adding, deleting or replacing a task by the day or according to a time slot.

21. A method according to claim 19, wherein the typing device is suitable for allowing a modification over a calendar period.

22. A method according to claim 19, further comprising means for displaying at least one class of distributed computers and that the typing means are suitable for associating a planning to the class.
